(19) United States
(12) Patent Application Publication
(10) Pub. No.: US 2004/0029006 A1
(43) Pub. Date: Feb. 12, 2004

(54) Electrodeposited copper foil and electrodeposited copper foil for secondary battery collector

(75) Inventors: Hideo Otsuka, Tochigi (JP); Akitoshi Suzuki, Tochigi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FURUKAWA CIRCUIT FOIL CO., LTD., Tokyo (JP)

(21) Appl. No.: 10/628,264

(22) Filed: Jul. 29, 2003

(30) Foreign Application Priority Data
Aug. 1, 2002 (JP) 2002-224471

(51) Int. Cl. H01M 4/36

(52) U.S. Cl. 429/220

(57) ABSTRACT

An electrodeposited copper foil having an extremely smooth surface roughness at the deposition surface, having an extremely fine crystal structure, and yet not having too high an ordinary temperature tensile strength, superior in elongation, maintaining a stable strength without softening by heat even after heat treatment, and having a high elongation rate even in a high temperature atmosphere. The electrodeposited copper foil has a surface roughness Rz at a deposition surface at ordinary temperature smaller than 2.5 μm in terms of 10-point average roughness Rz, has a minimum distance between peaks of a base foil peak of at least 5 μm, has an ordinary temperature tensile strength of not more than 40 kg/mm², and has a drop in ordinary temperature tensile strength after heat treatment at 130° C. for 15 hours of less than 15%. Also, copper foil for a secondary battery collector using that foil.

### BACKGROUND OF THE INVENTION

1. Field of the Invention

The present invention relates to an electrodeposited copper foil having an extremely smooth surface roughness at the deposition surface, having an extremely fine crystal structure, and yet not having too high an ordinary temperature tensile strength, superior in elongation, maintaining a stable strength without softening by heat even after heat treatment, and having a high elongation rate even in a high temperature atmosphere and an electrodeposited copper foil for a collector of a secondary battery comprised of this foil.

Further, the present invention relates to an electrodeposited copper foil for a collector of a secondary battery which increases the charge/discharge cycle life and is resistant to damage even with overcharging.

2. Description of the Related Art

In recent years, along with the reduction in size of mobile phones, video cameras, and other electronic devices, secondary batteries with high energy densities have become required. In particular, Li-ion batteries have superior properties such as high energy densities, superior charge/discharge cycle life, and light weight, so have come into wide use. The cathode collector of a Li-ion battery is generally made using copper foil. The collector is formed by coating the surface of the foil with carbon powder or other cathode active materials processed to a paste, drying this, then press flattening this by rolling etc. This is then rolled up together with a separator and aluminum foil coated with an anode active material to form the Li-ion battery.

As the copper foil used for the cathode collector, there are rolled copper foil obtained by rolling the copper and electrodeposited copper foil obtained by passing a current through a solution comprised mainly of copper sulfate to cause copper to deposit on a titanium or SUS rotating cathode and continuously peeling this off.

Up to now, the copper foil used for the cathode collector electrodes of Li-ion batteries has mainly been rolled copper foil. However, the rolled copper foil of a thickness of about 10 μm used for this is expensive. Further, it recrystallizes. Therefore, the tensile strength becomes extremely low. Accordingly, the handling ability in the step of coating and drying the carbon powder or other cathode active materials, then bonding the two by rolling becomes poor, wrinkles are easily caused, and sometimes the foil breaks. Further, the width of the copper foil produced by rolling is ordinarily about 60 cm. Therefore, there was also the defect of a poor efficiency at the time of production.

As opposed to this, electrodeposited copper foil has a larger tensile strength than rolled copper foil, which drops sharply in tensile strength upon recrystallization, so is superior in handling ability. Further, production of copper foil of a width of more than 100 cm is possible and productivity can be improved, so the foil is cheaper compared with rolled copper foil. Recently, there have been increased attempts to employ electrodeposited copper foil instead of rolled copper foil.

However, the deposition surface of a conventional electrodeposited copper foil features a columnar crystal structure. The surface roughness of the deposition surface of the electrodeposited copper foil is high, so it is learned that there are little contact portions with the carbon powder or other cathode active materials, the contact resistance is large, and the charge/discharge cycle life is short. Accordingly, an electrodeposited copper foil has been developed with a finer crystal structure and with a reduced surface roughness of the deposition surface on a par of that of a rolled copper foil. This has been put into use for Li-ion batteries.

As electrodeposited copper foils having fine crystal structures and surface roughnesses, there are the electrodeposited copper foils disclosed in Japanese Unexamined Patent Publication (Kokai) No. 7-188969, Japanese Unexamined Patent Publication (Kokai) No. 8-53789, and Japanese Unexamined Patent Publication (Kokai) No. 2000-182623. The electrodeposited copper foils disclosed there are reduced in the surface roughness of the deposition surfaces by controlling the various additives, electrolyte compositions, electrolyte temperatures, electrolyte flow rates, current densities, etc.

Two of the important properties in a secondary battery are the charge/discharge cycle life and the overcharge factor. Further improvement of these properties is sought. Regarding the charge/discharge cycle life, the stress etc. caused by expansion and contraction upon repeated charging and discharging causes the contact between the collector (copper foil) and active material to become poorer, part of the active material to become low electrically conductive and unable to be used for charging and discharging, and the capacity to deteriorate. Regarding the overcharge factor, it is required that splits or tears do not occur due to deterioration over time of the collector (copper foil) at the time of overcharging.

The electrodeposited copper foils having the finer crystal structures and lower surface roughnesses described in Japanese Unexamined Patent Publication (Kokai) No. 7-188969, Japanese Unexamined Patent Publication (Kokai) No. 8-53789, and Japanese Unexamined Patent Publication (Kokai) No. 2000-182623 are superior to the rolled copper foils of the past, but cannot be said to sufficiently meet the requirements of the market in terms of the charge/discharge cycle life and overcharge factor.

That is, the following conditions should be considered for electrodeposited copper foil for use as cathode collectors for Li-ion batteries:

1. Surface smoothness: The surfaces of the electrodeposited copper foils disclosed in the above three publications have 10-point average roughnesses Rz smaller than 2.5 μm, but if observing the surfaces by an electron microscope, fine crystal grainshaving an average particle size of several tenths of a micron are uniformly exposed and collect at the deposition surfaces, so the smoothness is not sufficient. Further, if these form base foil peak, the distance between peaks becomes several tenths of a micron the same as the grains. At such an uneven surface of an electrodeposited copper foil, the contact with the carbon powder or other cathode active materials is poor, therefore the capacity deteriorates and the charge/discharge cycle life drops. Note that the 10-point average roughness Rz is the value measured by a surface roughness meter based on JIS-B-0601.

2. Ordinary temperature tensile strength: The electrodeposited copper foils disclosed in the above three publications all have ordinary tensile strengths of over 50 kg/mm² and therefore are extremely hard. In general, in a copper foil comprised of fine crystals with an average particle size of the crystal structure of several tenths of a micron and having an 10-point average roughness Rz of not more than 2.5 μm, the ordinary temperature tensile strength becomes extremely high and a hard foil results. Since the copper foil is hard, the copper foil does not sufficiently deform along with the active material surface in the rolling or other press flattening step performed after coating the active material, contact with the active material becomes poor, and deterioration of the capacity and a drop in the charge/discharge cycle life are caused. Note that in general the fact that the tensile strength and hardness are in a proportional relationship is known.

3. Elongation rate at ordinary temperature: The elongation rates of the electrodeposited copper foils disclosed in the above three publications are all below 11%. Since the elongation rates are low in this way; stress is applied to the copper foils in the rolling or other press flattening step performed after coating the active material, the copper foils split, the capacities deteriorate, and the charge/discharge cycle lives drop.

4. Nonrecrystallization: The electrodeposited copper foil described in Japanese Unexamined Patent Publication (Kokai) No. 2000-182623 recrystallizes at around 130° C. Therefore, in the same way as rolled copper foil, the tensile strength sharply drops due to softening under heat and stretching wrinkles or tears occur at the time of coating the active material and heating for drying. Further, splits arise along the interface of the recrystallized structure and cause a drop in capacity and a drop in the charge/discharge cycle life.

5. Elongation rate in 180° C. high temperature atmosphere: The electrodeposited foil described in Example 2 of Japanese Unexamined Patent Publication (Kokai) No. 8-53789 has an elongation rate in a 180° C. high temperature atmosphere of 9.5% at a thickness of 35 μm. This is lower than an ordinary electrodeposited copper foil and further lower than the elongation rate at ordinary temperature. Therefore, in a test of the overcharge factor, the expansion stress due to the heat buildup at the time of overcharging cannot be withstood and defects such as splits occur in the copper foil. On the other hand, the electrodeposited copper foils described in Japanese Unexamined Patent Publication (Kokai) No. 7-188969 and Japanese Unexamined Patent Publication (Kokai) No. 2000-182623, which do not split in overcharge factor tests, have elongation rates in a high temperature atmosphere higher than the elongation rates at ordinary temperature.

### SUMMARY OF THE INVENTION

An object of the present invention is to provide an electrodeposited copper foil with a low surface roughness and an electrodeposited copper foil suitable for the collector of a cathode of a secondary battery.

According to a first aspect of the present invention, there is provided an electrodeposited copper foil having a surface roughness at a deposition surface at ordinary temperature smaller than 2.5 μm in terms of 10-point average roughness Rz, having a minimum distance between peaks of a base foil peak of at least 5 μm, having an ordinary temperature tensile strength of not more than 40 kg/mm², and having a drop in ordinary temperature tensile strength after heat treatment at 130° C. for 15 hours of less than 15%.

Preferably, the electrodeposited copper foil does not soften under heat after the heat treatment.

More preferably, the elongation rate at ordinary temperature is at least 14% at a thickness of 35 μm and the elongation rate increases along with a rise in temperature in an atmosphere from ordinary temperature to 200° C.

According to a second aspect of the invention, there is provided an electrodeposited copper foil for a secondary battery collector using such a foil.

Preferably, the secondary battery is a Li-ion battery.

### DESCRIPTION OF THE PREFERRED EMBODIMENTS

The present inventors engaged in intensive studies to reduce the defects etc. of the electrodeposited copper foils disclosed in the above publications so as to obtain an electrodeposited copper foil with a low surface roughness and as a result discovered that the important properties of the copper foil affecting the charge/discharge cycle life and the overcharge factor are the surface smoothness, which cannot be expressed by the 10-point average roughness Rz, ordinary temperature tensile strength, elongation rate, nonrecrystallization, and elongation rate in a high temperature atmosphere and thereby succeeded in obtaining a copper foil with the highest effects in secondary battery characteristics.

The electrodeposited copper foil of the present invention has surface roughness at its deposition surface smaller than 2.5 μm in terms of 10-point average roughness Rz. Regardless of this, there is no exposure of fine crystal grains of an average particle sizes of several tenths of a micron at the deposition surface as with other electrodeposited copper foil with low surface roughnesses and the distance between peaks of the base foil peak is at least 5 μm, so the surface is extremely smooth. Therefore, contact between the active material and collector is good, the electroconductivity becomes greater, and the charge/discharge cycle life is superior.

Even if the 10-point average roughness Rz is low, if crystal grains of an average particle size of 0.1 μm or more are exposed at the surface and the collector surface becomes rough, the contact points between the carbon powder active materials and collector will become smaller and the contact resistance will become greater. If repeatedly charging and discharging a secondary battery prepared using this copper foil, the stress accompanying expansion and contraction etc. will cause the distance between the collector and the active material to gradually increase and result in part of the active material becoming electroconductive unusable for charging and discharging and in the end deterioration of the capacity.

Therefore, it is necessary not only that the surface roughness of the electrodeposited copper foil be less than 2.5 μm in terms of 10-point average roughness Rz, but also that no fine crystal grains of an average particle size of several tenths of a micron be exposed at the deposition surface and that the distance between peaks of the rough surface be at least 5 μm. If the distance between peaks of the base foil peak is smaller than 5 μm, as explained above, the number of contact points with the cathode active material becomes smaller and a sufficient contact resistance can no longer be obtained.

Further, the electrodeposited copper foil according to the present invention has an ordinary temperature tensile strength of not more than 40 kg/mm² while has an extremely fine crystal structure, so the copper foil itself is soft.

In general, an electrode comprised of a flat collector formed on its surface with an electrode-forming substance layer is prepared by coating an electrode-forming substance containing an active material and binder on the surface of the collector, then pressing this by rolling etc. This pressing step has the action of compressing the electrode to a predetermined density and the action of bringing the active material particles closer to have suitable conductivity. The electrode after the pressing step has a small distance between active material particles and good contact between the active material and collector and a larger electroconductivity. Further, to obtain sufficient battery characteristics, it is important to make the distance between active material particles and between the active material and collector smaller and to have the collector deform in shape accordance with the shape of the active material surface. If the charge collector deforms in accordance with the active material surface, the contact between the active material and collector becomes better, the electroconductivity becomes further greater, and the charge/discharge cycle life is improved.

Therefore, the ordinary temperature tensile strength must not be more than 40 kg/mm². If the ordinary temperature tensile strength is more than 40 kg/mm², the softness of the copper foil itself is insufficient and the deformation of the copper foil along the active material surface in the processing for rolling or other press flattening performed after coating the active material does not sufficiently occur, so the contact with the active material becomes poor, the capacity deteriorates, and the charge/discharge cycle life drops and these are not preferable.

The electrodeposited copper foil according to the present invention preferably has an elongation rate at ordinary temperature of at least 14% at a thickness of 35 μm.

Further, the electrodeposited copper foil according to the present invention features a drop in the ordinary temperature tensile strength at the state St after heat treatment at 130° C. for 15 hours of less than 15% and does not recrystallize, so is superior in the charge/discharge cycle life and productivity.

Next, the present invention will be explained in more detail below with reference to examples and comparative examples, but of course the invention is not limited to these.

### EXAMPLE 1

7 ppm of low molecular weight gelatin having an average molecular weight of 3000, 3 ppm of hydroxyethyl cellulose, and 1 ppm of sodium 3-mercapto 1-propanesulfonate were added to a cupper sulfate electrolyte with sulfuric acid containing 280 g/liter of copper sulfate pentahydrate, 100 g/liter of sulfuric acid, and 35 ppm of chlorine ions. A foil was produced using this under conditions of an electrolyte temperature of 55° C., a flow rate of 0.3 m/min, and a current density of 50 A/dm². At this time, the electrolyte was passed through an activated carbon tower before entering the electrolysis tank and was brought to a boil after leaving the electrolysis tank after the end of the electrolysis, then was adjusted to the desired copper concentration, free sulfuric acid concentration, and chlorine ion concentration and provided again for electrolysis in a continuous cycle. Due to this, electrodeposited copper foils having a thickness of 35 μm for measurement of foil properties and having a thickness of 12 μm for use for a secondary battery electrode were produced.

The electrodeposited copper foil of the thickness of 35 μm obtained was used to test the characteristics of the foil for the items shown in Table 1. The results are shown in Table 1. The 10-point average roughness Rz was measured by an SE-3C type surface roughness meter made by Kosaka laboratory Co. based on JIS-B-0601. Further, the minimum distance between peaks Ds of the base foil peak was measured from a photograph taken at a magnification of X2000 by an electron microscope. The tensile strength and elongation rate at ordinary temperature, at 180° C. and 200° C. high temperature atmospheres, and after being returned to ordinary temperature after heat treatment at 150° C. for 15 hours were measured based on IPC-TM-650. In Table 1, the state when returned to ordinary temperature after heat treatment at 150° C. for 15 hours is indicated as “State St” Note that when the ordinary temperature tensile strength and elongation rate were measured right after production of the foil, strain from the time of electrolysis remained, so these appeared high in trend. Therefore, these properties were measured after leaving the foils standing at ordinary temperature for three days.

Further, the electrodeposited copper foil of the thickness of 12 μm was immersed in a 1 g/liter concentration CrO₃ aqueous solution for 5 seconds and chromating and then rinsed and dried. Note that here chromating was applied, but benzotriazole series treatment or silane coupling treatment may also be performed of course.

The thus obtained 12 μm thick electrodeposited copper foil was used to fabricate the chathode of a secondary battery in the following way. As the cathode active material, 90 wt % of a coke material powder obtained by sintering petroleum pitch, pulverizing the obtained coarse grain pitch coke to an average particle size of 20 μm, then sintering this in an inert gas at 1000° C. to remove impurities was mixed with 10 wt % of polyvinylidene fluoride as a binder to prepare a cathode composition. Next, this cathode composition was dispersed in a solvent of N-methyl 2-pyrrolidone to make a slurry which was coated and dried on the two surfaces of the electrodeposited copper foil which was then pressed by a roller press to a strip shape to obtain the cathode. This strip-shaped cathode had thicknesses of the cathode composition after forming of a same 90 μm on its two surfaces, a width of 55.6 mm, and a length of 551.5 mm. Next, the anode was prepared using LiCoO₂ as an anode active material, mixing 91 wt % of this, 6 wt % of graphite as a conductive agent, and 3 wt % of polyvinylidene fluoride as a binder to prepare an anode composition, then dispersing this in N-methyl 2-pyrrolidone to make a slurry.

Next, this slurry was uniformly coated and dried on the two surfaces of an anode collector comprised of 20 μm thick strip-shaped aluminum which was then pressed by a roller press to obtain a strip-shaped anode of 160 μm thickness. This strip-shaped anode had thicknesses of the anode composition after forming of 70 μm on its two surfaces, a width of 53.6 mm, and a length of 523.5 mm. The thus prepared strip-shaped anode and strip-shaped catahode were laminated with a separator having a thickness of 25 μm and a width of 58.1 mm comprised of microporous polypropylene film to form a multilayer electrode member. This multilayer electrode member was rolled up along the longitudinal direction with the cathode at the inside in a spiral manner into several layers. The endmost part of the outermost layer separator was secured by tape to obtain a spiral-shaped electrode member.

The thus formed hollow tube of this spiral-shaped electrode member had an inside diameter of 35 mm and an outside diameter of 17 mm. The thus prepared spiral-shaped electrode member was inserted into a steel battery case plated with nickel in a state with insulator plates above and below it, leads were attached, then 5.0 g of a nonaqueous electrolyte obtained by dissolving LiPF₆ at a ratio of 1 mole/liter into an equal volume mixed solvent of propylene carbonate and diethyl carbonate was injected and the assembly sealed to obtain a cylindrical Li-ion battery. This Li-ion battery was investigated as to its capacity retention rate R_{B} after 100 cycles and for the presence of breakage of the copper foil by disassembling the battery after overcharging by DC 2A for 40 minutes. The number of tears in the copper foil after this overcharging was expressed by N_{B}. The results are shown in Table 1.

### EXAMPLE 2

10 ppm of hydroxyethyl cellulose and 1 ppm of sodium 3-mercapto 1-propanesulfonate were added to a cupper sulfate electrolyte with sulfuric acid containing 280 g/liter of copper sulfate pentahydrate, 100 g/liter of sulfuric acid, and 50 ppm of chlorine ions. A foil was produced using this under conditions of an electrolyte temperature of 55° C., a flow rate of 0.5 m/min, and a current density of 50 A/dm². At this time, the electrolyte was passed through an activated carbon tower before entering the electrolysis tank and was brought to a boil after leaving the electrolysis tank after the end of the electrolysis, then was adjusted to the desired concentration and provided again for electrolysis in a continuous cycle. Due to this, electrodeposited copper foils having a thickness of 35 μm and 12 μm were produced and tested for characteristics in the same way as in Example 1. The results are shown in Table 1. The electrodeposited copper foil of the thickness of 12 μm was used to fabricate a Li-ion battery in the same way as in Example 1. In the same way as in Example 1, this was investigated as to its capacity retention rate R_{B}, after 100 cycles and for the presence of breakage of the copper foil by disassembling the battery after overcharging by DC 2A for 40 minutes. The results are shown in Table 1.

### EXAMPLE 3

10 ppm of low molecular weight gelatin having an average molecular weight of 3000, 3 ppm of hydroethyl cellulose, and 1 ppm of sodium 3-mercapto 1-propanesulfonate were added to a cupper sulfate electrolyte with sulfuric acid containing 280 q/liter of copper sulfate pentahydrate, 100 g/liter of sulfuric acid, and 50 ppm of chlorine ions. A foil was produced using this under conditions of an electrolyte temperature of 55° C., a flow rate of 0.3 m/min, and a current density of 50 A/dm². At this time, the electrolyte was passed through an activated carbon tower before entering the electrolysis tank and was brought to a boil after leaving the electrolysis tank after the end of the electrolysis, then was adjusted to the desired concentration and provided again for electrolysis in a continuous cycle. Further, the deposition surface of this electrodeposited copper foil was plated to give a copper gloss by adding 10 cc/liter of a makeup agent of Copperacid 210 made by Schering Co., 0.5 cc/liter of a gloss agent (A), and replenishing amounts of a gloss agent (B) to an electrolyte of 200 g/liter of copper sulfate pentahydrate, 60 g/liter of sulfuric acid, and 40 ppm of chlorine ions of a liquid temperature of 55° C. Due to this, electrodeposited copper foils having a thickness of 35 μm and 12 μm were produced and tested for characteristics in the same way as in Example 1. The results are shown in Table 1. The electrodeposited copper foil of the thickness of 12 μm was used to fabricate a Li-ion battery in the same way as in Example 1. In the same way as in Example 1. this was investigated as to its capacity retention rate R_{B} after 100 cycles and for the presence of breakage of the copper foil by disassembling the battery after overcharging by DC 2A for 40 minutes. The results are shown in Table 1.

### Comparative Example 1

Electrodeposited copper foils having thicknesses of 35 μm and 12 μm were produced under the conditions of Example 1-A described in Japanese Unexamined Patent Publication (Kokai) No. 7-188969 and tested for properties in the same way as in Example 1. The results are shown in Table 1. Further, the 12 μm thickness copper foil was used to produce a Li-ion battery in the same way as in Example 1. In the same way as in Example 1, the capacity retention rate R_{B} after 100 cycles and the presence of breakage to the copper foil after disassembling the battery after overcharging by a direct current of 2A for 40 minutes were investigated. The results are shown in Table 1.

### Comparative Example 2

Electrodeposited copper foils having thicknesses of 35 μm and 12 μm were produced under the conditions of Example 2 described in Japanese Unexamined Patent Publication (Kokai) No. 8-53789 and tested for properties in the same way as in Example 1. The results are shown in Table 1. Further, the 12 μm thickness copper foil was used to produce a Li-ion battery in the same way as in Example 1. In the same way as in Example 1, the capacity retention rate R_{B} after 100 cycles and the presence of breakage to the copper foil after disassembling the battery after overcharging by a direct current of 2A for 40 minutes were investigated. The results are shown in Table 1.

### Comparative Example 3

Electrodeposited copper foils having thicknesses of 35 μm and 12 μm were produced under the conditions of Example 1 described in Japanese Unexamined Patent Publication (Kokai) No. 2000-182623 and tested for properties in the same way as in Example 1. The results are shown in Table 1. Further, the 12 μm thickness copper foil was used to produce a Li-ion battery in the same way as in Example 1. In the same way as in Example 1, the capacity retention rate R_{B} after 100 cycles and the presence of breakage to the copper foil after disassembling the battery after overcharging by a direct current of 2A for 40 minutes were investigated. The results are shown in Table 1.

TABLE 1

| | | Mini- | | | | | | | | | |
|---|---|---|---|---|---|---|---|---|---|---|---|
| | | mum | Ordinary | | | | State St | | | | |
| | | dis- | temperature | | | | Tensile | | Reduc- | | |
| | | tance | Tensile | | 180° C. | 200° C. | stren- | | tion | Reten- | |
| | Rough- | bet- | strength | | elonga- | elonga- | gth | Elonga- | rate | tion | |
| | ness | ween | (A) | Elongation | tion | tion | (B) | tion | (1- | rate | No. of |
| | Rz | peaks | (kg/ | rate | rate | rate | (kg/ | rate | B/A | R_{B} | tears |
| | (μm) | Ds (μm) | mm²) | (%) | (%) | (%) | mm²) | (%) | (%) | (%) | N_{B} |
| Ex. 1 | 1.3 | 5.2 | 32 | 18 | 24 | 26 | 31 | 19 | 3.1 | 95 | 0 |
| Ex. 2 | 2.1 | 5.0 | 38 | 14 | 18 | 21 | 37 | 15 | 2.6 | 91 | 0 |
| Ex. 3 | 1.2 | 5.4 | 36 | 17 | 22 | 25 | 35 | 18 | 2.8 | 95 | 0 |
| Comp. | 2.0 | 0.8 | 67 | 8 | 23 | 24 | 65 | 8 | 3.0 | 71 | 0 |
| Ex. 1 | | | | | | | | | | | |
| Comp. | 2.4 | 1.2 | 51 | 11 | 9 | 6 | 50 | 11 | 2.0 | 62 | 21 |
| Ex. 2 | | | | | | | | | | | |
| Comp. | 1.6 | 0.5 | 56 | 7 | 26 | 23 | 23 | 26 | 59.0 | 78 | 0 |
| Ex. 3 | | | | | | | | | | | |

In Examples 1 to 3, the electrodeposited copper foils of the present invention had 10-point average roughnesses Rz of not more than 2.5 μm and yet had minimum distances between peaks Ds of the base foil peak of at least 5 μm and had fine crystal structures at ordinary temperature yet had ordinary temperature tensile strengths of not more than 40 kg/mm² and ordinary temperature elongation rates of at least 14% at 35 μm thicknesses. Further, the drops in ordinary temperature tensile strengths at the state St after heat treatment at 130° C. for 15 hours were within 15%. The foils did not soften under heat and tended to rise in elongation rates along with the rise of temperature from ordinary temperature to a high temperature atmosphere of 200° C. The elongation rates in 180° C. atmosphere were at least 18% at 35 μm thicknesses. Due to these characteristics and explained as follows, the charge/discharge cycle life and overcharge factor were satisfied.

That is, the electrodeposited copper foil of the present invention did not have fine crystal grains of an average particle size of several tenths of a micron exposed at the deposition surface and therefore was extremely smooth, so exhibited good contact with the active material. Further, while the crystal structure was extremely fine, the ordinary temperature tensile strength was not too high, so the collector sufficiently deformed along with the active material and good contact between the active material and collector could be maintained. On top of this, the elongation rate at ordinary temperature was high, so it was possible to prevent splits in the copper foil in the rolling or other press flattening step performed after coating the active material. Further, the foil did not recrystallize, so it was superior in charge/discharge cycle life and had an elongation rate which was high in a high temperature atmosphere and increased along with the rise in temperature. Therefore, by employing this electrodeposited copper foil, it was possible to provide an electrodeposited copper foil for a secondary battery collector superior in overcharge factor.

Conventionally, rolled copper foil, which had been used as a copper foil for a secondary battery collector and a part of electrodeposited copper foil recrystallize at one hundred and several ten ° C. Therefore, when using as a collector, the tensile strength of them drop over time and expansion and contraction of active material accompanying charge/discharge causes split and breakage of collector copper foil, the capacities deteriorate, the charge/discharge cycle lives drop, and especially splits arise easily along the interface of the recrystallized structure.

Further, since tensile strength becomes extremely small after recrystallize. Accordingly, the handling ability in the step of coating and drying the cathode active material substance, wrinkles are easily caused, and sometimes the foil breaks. Therefore, it is needed for a copper foil for a secondary battery collector not to recrystallize. The electrodeposited copper foil of the present invention does not split and tear because it dose not recrystallize, has a long charge/discharge cycle life, and has a good handling ability. To satisfy the above conditions, the drops in ordinary temperature tensile strengths of the electrodeposited copper foil at the state St after heat treatment at 130° C. for 15 hours is decided to be within 15%.

If the above described elongation rate is low, stress is applied to the copper foils in the rolling or other press flattening step performed after coating the active material, the copper foils split, the capacities deteriorate, and the charge/discharge cycle lives drop. Therefore, it is preferable that the elongation rate at ordinary temperature of the electrodeposited copper foil is at least 14%.

Further, the electrodeposited copper foil of the present invention has an elongation rate increases in temperature in an atmosphere from ordinary temperature to 200° C. And the elongation rate in a 180° C. atmosphere is at least 18% at 35 μm thickness. Therefore, the copper foil of the present invention exhibits the properties of superior overcharge factor of the secondary battery.

On the other hand, comparative Example 1 showed a smooth foil having a 10-point average roughness Rz of 2.0 μm and a fine crystal structure, but having a minimum distance between peaks of the base foil peak of 0.8 μm. Therefore, there were few contact points with the carbon powder active materials and the contact resistance became large. The stress accompanying expansion and contraction during the charge/discharge cycle caused the distance between the collector and the active material to gradually increase and resulted in part of the active material becoming electroconductive unusable for charging and discharging and therefore deterioration of the capacity. Further, compared with the electrodeposited copper foils of Examples 1 to 3, the ordinary temperature tensile strength was high and the foil extremely hard and the ordinary temperature elongation rate also low. Therefore, the copper foil did not sufficiently deform along with the active material surface in the rolling or other press flattening step, contact with the active material was poor, splits occurred in part of the copper foil, the capacity deteriorated, and the charge/discharge cycle life dropped.

Comparative Example 2 is similar to Comparative Example 1, but has a further lower elongation rate in a high temperature atmosphere and a rate lower than the value at ordinary temperature as well. Therefore, in a test of the overcharge factor, the expansion stress due to the heat buildup at the time of overcharging cannot be withstood and tears occurred in the copper foil.

Comparative Example 3 is similar to Comparative Example 1, but when heat treated at 130° C. for 15 hours had an ordinary temperature tensile strength dropping down to 23 kg/mm² and recrystallized. Therefore, due to the expansion and contraction of the active material accompanying the charging and discharging, splits and tears occurred in the collector copper foil, the capacity dropped, and the charge/discharge cycle life fell.

Summarizing the effects of the invention, the electrodeposited copper foil of the present invention is extremely smooth with a low surface roughness at the deposition surface and has an extremely fine crystal structure, yet does not have too high an ordinary temperature tensile strength, is superior in elongation rate, maintains a stable strength without softening under heat even after heat treatment, is superior in elongation rate even in a high temperature atmosphere, and is therefore suitable for copper foil for a collector of a secondary battery. It exhibits the properties of a long charge/discharge cycle life of the secondary battery and superior overcharge factor as well and therefore has a superior industrial effect.

While the invention has been described with reference to specific embodiments chosen for purpose of illustration, it should be apparent that numerous modifications could be made thereto by those skilled in the art without departing from the basic concept and scope of the invention.

What is claimed is:

1. An electrodeposited copper foil having a surface roughness at a deposition surface at ordinary temperature smaller than 2.5 μm in terms of 10-point average roughness Rz, having a minimum distance between peaks of a base foil peak of at least 5 μm, having an ordinary temperature tensile strength of not more than 40 kg/mm², and having a drop in ordinary temperature tensile strength after heat treatment at 130° C. for 15 hours of less than 15%.

2. An electrodeposited copper foil as set forth in claim 1, which does not soften under heat after said heat treatment.

3. An electrodeposited copper foil as set forth in claim 2, wherein the elongation rate at ordinary temperature is at least 14% at a thickness of 35 μm and wherein the elongation rate increases along with a rise in temperature in an atmosphere from ordinary temperature to 200° C.

4. An electrodeposited copper foil for a secondary battery collector using a foil as set forth in any one of claims 1 to 3.

5. An electrodeposited copper foil for a secondary battery collector as set forth in claim 4, wherein said secondary battery is a Li-ion battery.
